(19) United States
(12) Patent Application Publication
(10) Pub. No.: US 2013/0049461 A1
(43) Pub. Date: Feb. 28, 2013

(54) CIRCUIT TOPOLOGY OF PRINTED CIRCUIT BOARD

(71) Applicants: SHI-PIAO LUO, Shenzhen City (CN); HUA-LI ZHOU, Shenzhen City (CN); CHIA-NAN PAI, Tu-Cheng (TW); SHOU-KUO HSU, Tu-Cheng (TW)

(72) Inventors: SHI-PIAO LUO, Shenzhen City (CN); HUA-LI ZHOU, Shenzhen City (CN); CHIA-NAN PAI, Tu-Cheng (TW); SHOU-KUO HSU, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/336,000

(22) Filed: Dec. 23, 2011

(30) Foreign Application Priority Data
Aug. 25, 2011 (CN) 201110245716.4

(51) Int. Cl. H02J 4/00

(52) U.S. Cl. 307/11

(57) ABSTRACT

A circuit topology for multiple loads includes a driving terminal, first and second signal receiving terminals, and a capacitor. The driving terminal is connected to a node through a first transmission line. The node is connected to the first and second signal receiving terminals through second and third transmission lines. The second transmission line is longer than the third transmission line, and a difference between lengths of the second and third transmission lines is greater than a product of a transmission speed and a rise time of signals from the driving terminal. A first terminal of the capacitor is connected to the third transmission line. A second terminal of the capacitor is grounded. A distance between the capacitor and the second signal receiving terminal is less than a distance between the capacitor and the node.

### BACKGROUND

1. Technical Field

The present disclosure relates to a circuit topology of a printed circuit board (PCB).

2. Description of Related Art

With the increasing speeds of integrated circuits (ICs), signal integrity is becoming one of the most pressing problem areas. Many factors, such as the parameters of the electrical elements of the PCB and the layout of the PCB, can affect the signal integrity, or lead to instability of the system, possibly even causing the system to breakdown. Thus, preserving signal integrity has become a key point in the design of a PCB.

Referring to FIG. 4, a related-art circuit topology coupling a driving terminal to two signal receiving terminals is shown. A driving terminal 10 is coupled to two signal receiving terminals 20 and 30 through corresponding transmission lines. The two signal receiving terminals 20 and 30 are connected together in a daisy-chain configuration. In this circuit topology, the distance a signal travels from the driving terminal 10 to the signal receiving terminal 20 is greater than the distance the signal travels from the driving terminal 10 to the signal receiving terminals 30.

Referring to FIG. 5, a graph illustrating signal waveforms 22 and 33 respectively obtained at receiving terminals 20 and 30 using the circuit topology of FIG. 4 is shown. Signals arriving at the receiving terminal 30 reflect back and forth along the transmission line causing “ringing” at the receiving terminal 20.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of a circuit topology in accordance with a first embodiment.

FIG. 2 is a comparative graph showing signal waveforms obtained at each signal receiving terminal using the circuit topology of FIG. 1.

FIG. 3 is a block diagram of a circuit topology in accordance with a second embodiment.

FIG. 4 is a block diagram of a related-art circuit topology coupling a driving terminal to two signal receiving terminals.

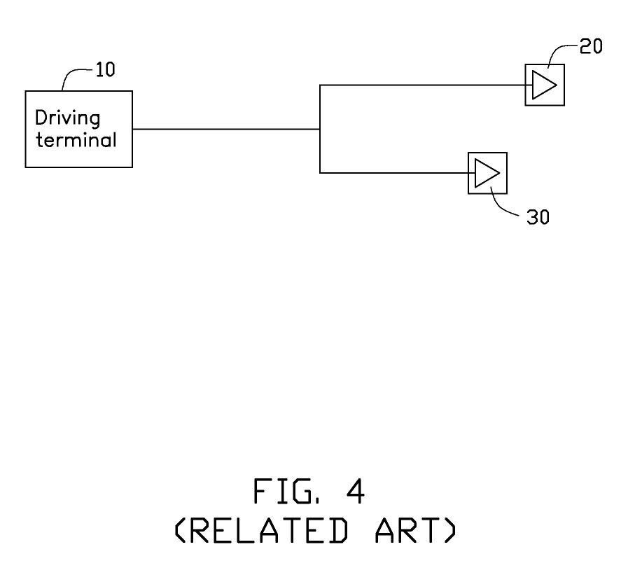

FIG. 5 is a comparative graph showing signal waveforms obtained at each signal receiving terminal using the circuit topology of FIG. 4.

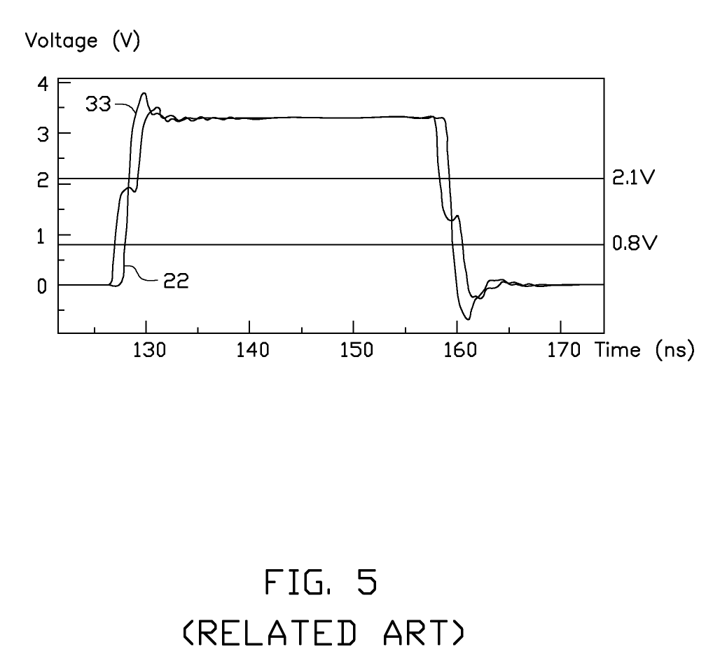

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

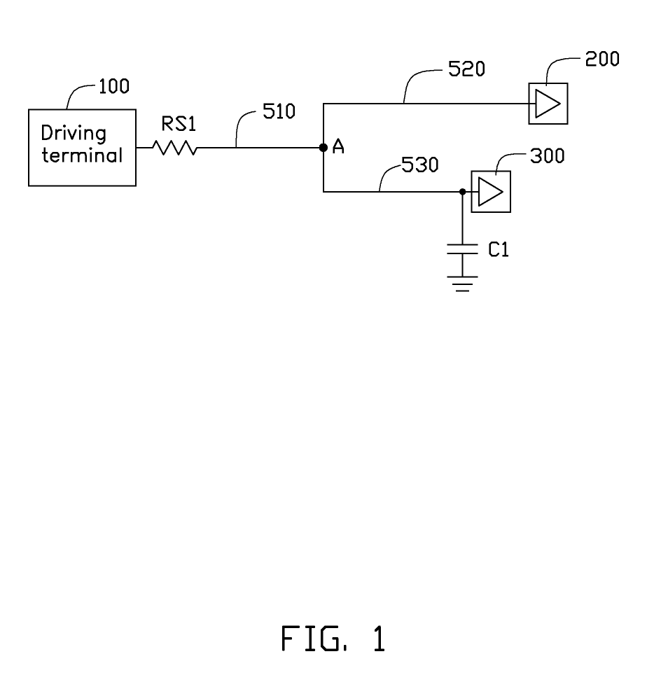

Referring to FIG. 1, a first embodiment of a circuit topology set on a signal layer of a printed circuit board includes a driving terminal 100, two signal receiving terminals 200 and 300, a resistor RS1, transmission lines 510, 520, and 530, and a capacitor C1. The driving terminal 100 is coupled to a node A through the transmission line 510. The node A is coupled to the signal receiving terminals 200 and 300 respectively through transmission lines 520 and 530. The resistor RS1 is connected in the transmission line 510. A first terminal of the capacitor C1 is connected to the transmission line 530. A second terminal of the capacitor C1 is grounded. A distance between the capacitor C1 and the signal receiving terminal 300 is less than a distance between the capacitor C1 and the node A.

In this embodiment, the difference between the length of the transmission line 520 and 530 is greater than the product of a transmission speed and a rise time of the signal from the driving terminal 100. The resistance of the resistor RS1 is chosen to be matched with the impedance of the transmission line 510.

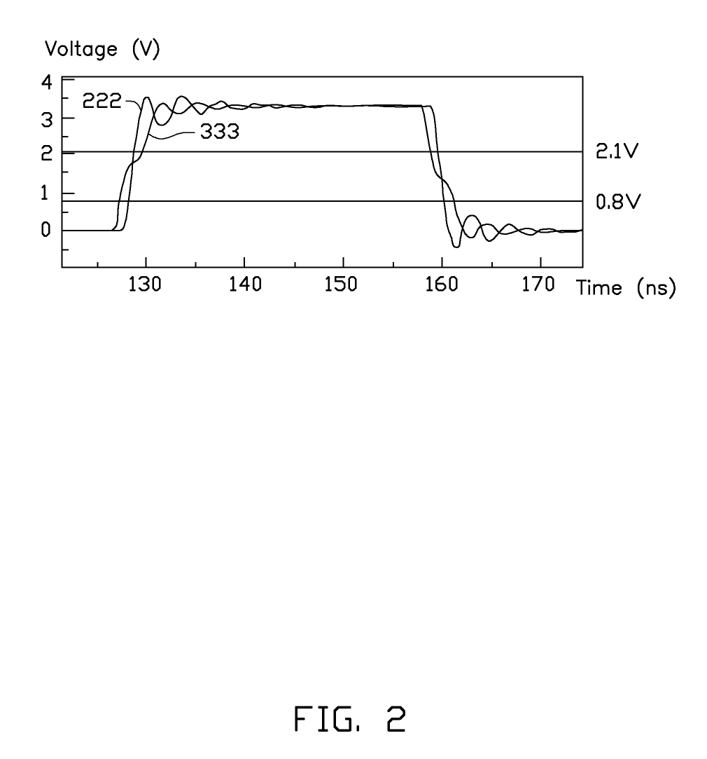

FIG. 2 is a graph showing signal waveforms obtained at each signal receiving terminal 200 and 300 using the circuit topology of FIG. 1. Signal waveforms 222 and 333 are corresponding to the signal receiving terminals 200 and 300. It can be seen that with the first resistor RS1 and the capacitor C1, signal reflections are reduced and signal integrity is improved at the signal receiving terminals 200 and 300.

In the first embodiment, the circuit topology just includes two branches. In other embodiments, the circuit topology may include more than two branches. In this condition, for each branch, if the difference between the lengths of the two transmission lines is greater than the product of a transmission speed and a rise time of the signal from the driving terminal 100, a capacitor is connected to the shorter transmission line. A distance between the capacitor and the corresponding signal receiving terminal is less than a distance between the capacitor and the corresponding node. As a result, signal integrity at the signal receiving terminals can be improved.

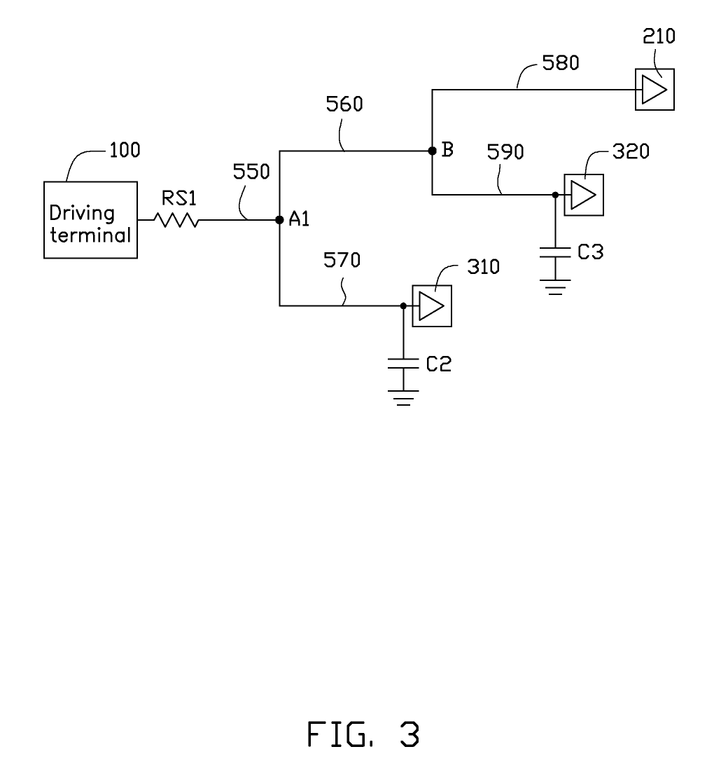

Referring to FIG. 3, a second embodiment of a circuit topology for multiple loads is set on a signal layer of a printed circuit board. The circuit topology includes a driving terminal 100, three signal receiving terminals 210, 310, and 320, a resistor RS1, two capacitors C2 and C3, and transmission lines 550, 560, 570, 580, and 590. The driving terminal 100 is coupled to a node A1 through the transmission line 550. The node A1 is coupled to the signal receiving terminal 310 and a node B respectively through transmission lines 570 and 560. The node B is coupled to the signal receiving terminals 210 and 320 respectively through the transmission lines 580 and 590. The resistor RS1 is connected in the transmission line 550. The resistance of the resistor RS1 is chosen to be matched with the impedance of the transmission line 550.

An equivalent length of the transmission lines from the node A1 to the signal receiving terminals 210 and 320 is greater than the length of the transmission line 570. The difference between an equivalent length of the transmission lines from the node A1 to the signal receiving terminals 210 and 320, and the transmission line 570 is greater than the product of a transmission speed and a rise time of the signal from the driving terminal 100. In this condition, a first terminal of the capacitor C2 is connected to the transmission line 570. A second terminal of the capacitor C2 is grounded. A distance between the capacitor C2 and the signal receiving terminal 310 is less than a distance between the capacitor C2 and the node A1. As a result, signal integrity at the signal receiving terminal 310.

The transmission line 580 is longer than the transmission line 590. The difference between the length of the transmission lines 580 and 590 is greater than the product of the transmission speed and the rise time of the signal from the driving terminal 100. A first terminal of the capacitor C3 is connected to the transmission line 590. A second terminal of the capacitor C3 is grounded. A distance between the capacitor C3 and the signal receiving terminal 320 is less than a distance between the capacitor C3 and the node B. As a result, signal integrity at the signal receiving terminals 210, 310, and 320 can be improved.

The foregoing description of the exemplary embodiments of the disclosure has been presented only for the purposes of illustration and description and is not intended to be exhaustive or to limit the disclosure to the precise forms disclosed. Many modifications and variations are possible in light of everything above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A circuit topology for multiple loads, comprising:
a node;
a driving terminal connected to the node through a first transmission line;
a first signal receiving terminal connected to the node through a second transmission line;
a second signal receiving terminal connected to the node through a third transmission line; and
a capacitor, wherein a first terminal of the capacitor is connected to the third transmission line and a second terminal of the capacitor is grounded;
wherein the second transmission line is longer than the third transmission line, and a difference between lengths of the second and third transmission lines is greater than a product of a transmission speed and a rise time of signals from the driving terminal, a distance between the capacitor and the second signal receiving terminal is less than a distance between the capacitor and the node.

2. The circuit topology of claim 1, further comprising a resistor connected in series with the first transmission line, wherein a resistance of the resistor is chosen to accomplish impedance matching of the first transmission line.

3. A circuit topology for multiple loads, comprising:
a first node;
a driving terminal connected to the first node through a first transmission line;
a first signal receiving terminal connected to the first node through a second transmission line;
a second node connected to the first node through a third transmission line;
a second signal receiving terminal connected to the second node through a fourth transmission line;
a third signal receiving terminal connected to the second node through a fifth transmission line;
a first capacitor, wherein a first terminal of the first capacitor is connected to the second transmission line, and a second terminal of the first capacitor is grounded; and
a second capacitor, wherein a first terminal of the second capacitor is connected to the fifth transmission line, and a second terminal of the second capacitor is grounded;
wherein a length of the second transmission line is less than an equivalent length from the first node to the second signal receiving terminal, a length of the fifth transmission line is less than a length of the fourth transmission line, a difference between the length of the second transmission line and the equivalent length from the first node and the second signal receiving terminal is greater than a product of a transmission speed and a rise time of signals from the driving terminal, a difference between the length of the fourth and fifth transmission lines is greater than the product of the transmission speed and the rise time of signals from the driving terminal, a distance between the first capacitor and the first signal receiving terminal is less than a distance between the first capacitor and the first node, a distance between the second capacitor and the third signal receiving terminal is less than a distance between the second capacitor and the second node.

4. The circuit topology of claim 3, further comprising a resistor connected in series with the first transmission line, wherein a resistance of the resistor is chosen to accomplish impedance matching of the first transmission line.
